(19) United States
(12) Patent Application Publication
(10) Pub. No.: US 2012/0267880 A1
(43) Pub. Date: Oct. 25, 2012

(54) AIRBAG FOR MOTOR VEHICLES AND METHOD FOR MANUFACTURING AN AIRBAG

(75) Inventors: Henrik Frisk, Goteborg (SE); Börje Jacobsson, Bramhult (SE); Ola Henriksson, Vargarda (SE); Carl-Johan Svensson, Vargarda (SE); Mats Berntsson, Goteborg (SE); Fredrik Kjell, Alingsas (SE); Stefan Andersson, Alingsas (SE)

(73) Assignee: AUTOLIV DEVELOPMENT AB, Vargarda (SE)

(21) Appl. No.: 13/516,283

(22) PCT Filed: Dec. 13, 2010
(86) PCT No.: PCT/SE2010/051365

§ 371 Date: Jun. 27, 2012

(30) Foreign Application Priority Data
Dec. 18, 2009 (DE) 102009059702.6

(51) Int. Cl. B60R 21/232; B30B 13/00; B60R 21/231

(52) U.S. Cl. 280/730.2; 280/743.1; 100/40

(57) ABSTRACT

An airbag for a motor vehicle includes an airbag skin having two side walls which enclose a gas chamber. The airbag skin is at least partially rolled to a shaped package in the resting state of the curtain airbag, with the shaped package having a non-circular cross-section. In order to provide a cost-effective way to produce such an airbag and to ensure that the airbag shows a deployment behaviour of a rolled package, the non-circular cross-section is permanent as long as the pressure inside the gas chamber does not exceed the pressure of the environment and is obtainable by plastic conversion of a rolled package with a circular cross-section.

### TECHNICAL FIELD OF THE INVENTION

The invention relates to an airbag according to the preamble of claim 1 and to a method for its manufacture according to claim 13.

So-called curtain airbags are widely used in the automotive industry. They serve for the protection mainly of the head of a vehicle occupant in case of a side impact or a roll-over accident.

A curtain airbag comprises an airbag skin with two parallel side walls which enclose a gas chamber. The side walls usually have a rather large surface and the airbag skin is rolled and/or folded to a package whose diameter is small compared to its length. The upper edge of the airbag skin is directly or indirectly mounted to the inner structure of the vehicle and the curtain airbag is covered by the ceiling. Here, a general problem is that the space available between the inner structure and the ceiling is limited.

### PRIOR ART

Two basic concept of forming the airbag skin to a package are known in the prior art:

In the first concept, the airbag skin is folded with a so-called Z-folding like an accordion. This kind of forming the package has the advantage that one is relatively free in defining the cross section of the package. Especially it is possible to fold the airbag skin such that the package has a basically rectangular shape with a longer side and a shorter side, which often fits better into the space available between the inner structure of the vehicle (mostly the roof rail) and the ceiling. A curtain airbag with such a folding is for example known from DE 10 2004 052 466 A1.

In a second concept, the airbag skin is rolled to a package. This has the advantage that the deployment behaviour is generally superior in relation the deployment behaviour of a folded curtain airbag. Generally it is preferred that the package is rolled to an “outboard” roll which means that the airbag skin unrolls towards the outside during deployment leading to a gentle behaviour towards the occupant. An especially good deployment behaviour is achieved when the upper edge of the airbag skin points downwards in the mounted state. Such a configuration is for example shown in WO 2005/049390 A1 (so-called p-roll).

A variation of this type of packaging is for example known from WO 2002/085674 A1. Here, the main section of the airbag skin is rolled to a package and a further section extending between the main section and the upper edge of the airbag skin shows one fold. The cross-section of the total package including the further section is mainly defined by the shape of the rolled package.

The drawback of a curtain airbag whose airbag skin is completely or to a large part rolled to a package is that the package has usually a circular cross-section which does often not use the available space in an ideal way.

The generic patent document WO 2004/094198 A1 describes a method for packing a curtain airbag. Here, the airbag skin of the curtain airbag is first rolled to a package and the package is then deformed by means of one or more deformation elements pushing into the rolled package. By this deformation of the rolled package it is possible to generate cross-sections of the package that differ from a circle, but two drawbacks need to be accepted. First, additional measures must be taken in order to keep the new formed package (the deformed rolled package) in its new shape. Without such measures—usually a cover is wrapped around the package—the package would return into its original state, namely a rolled package with a basically circular cross-section. This applying of a cover makes of course additional efforts—and thus costs—necessary, which is not desired. Second, the package obtained by such a deformation is no roll anymore in the following geometrical sense: The geometrical characteristic of a roll is that if one follows the roll—for example from the lower edge to the upper edge of the airbag skin—the direction of curvature is monotonous: One has either a left curvature or a right curvature. This is no more the case in a package as described in the WO 2004/094198 A1: Here, one has sections with left and sections with right curvature and thus in some cases the perfect deployment behaviour of a “real” roll may not be achieved.

### SUMMARY OF THE INVENTION

Starting form this the invention sets itself the problem to improve a generic airbag and a generic method for manufacture of such an airbag in such a way that the curtain airbag is easy and thus cost effective to manufacture and shows the deployment behaviour of a rolled package.

This problem is solved by an airbag according to claim 1 and a method for the manufacture of such an airbag according to claim 13.

According to the invention at least a part the airbag skin is a rolled package with a non-circular cross-section; this rolled package is referred to as “shaped package”. The non-circular cross-section is permanent as long as the airbag is not deployed, that means as long as the pressure in the gas chamber does not exceed the pressure of the environment. This permanent non-circular cross-section can be obtained by a plastic, especially a thermoplastic, deformation of a rolled package, especially of a rolled package with a circular cross-section.

The production of the airbag according to the invention is quite easy: The airbag skin is first rolled to a package like a “traditional” rolled airbag. The entire airbag is then inserted into a press with at least two plates. The rolled package is pressed between these two plates and kept there for a certain amount of time. Depending on the material of the airbag skin and/or a coating of the airbag skin, heat is applied to the pressed package, preferably by heating at least one of the plates. Due to memory effects of the airbag skin and/or its coating the rolled package does not return to its original circular cross-section but remains basically in the shape applied by the plates. In the simplest and most common case, the package is pressed between two plates being parallel to each other. As a result, the shaped package has an oval shape with a longer side and a shorter side (mathematically more correct one should say: a maximum diameter and a minimum diameter). The mentioned memory effects result in most cases from a softening or “near melting” of airbag skin material and/or coating material during the pressing and a “re-solidification” after the pressing of the package.

Since the usually used Polyamide (Nylon, PA) for the plastic fabric of the airbag skin has a rather high melting point, it is in many applications to be preferred that the airbag skin is coated, preferably with a coating made of thermoplastic components.

The invention will now be described in detail by means of examples in view of the accompanying drawings. The drawings show:

### BRIEF DESCRIPTION OF THE DRAWINGS

FIG. 1: a bird eye's view to a curtain airbag;

FIG. 2: the sectional view along the cutting plane A-A in FIG. 1;

FIG. 3: what is shown in FIG. 3 and a cylinder;

FIG. 4: the curtain airbag of FIG. 3 after the airbag skin has been wrapped around the cylinder;

FIG. 5: the curtain airbag of FIG. 4 after the cylinder has been removed;

FIG. 6: the curtain airbag of FIG. 5 located between the plates of a press;

FIG. 7: what is shown in FIG. 6 after the press has been activated;

FIG. 8: the curtain airbag after it has been released from the press, and a stiff mounting element;

FIG. 9: The curtain airbag of FIG. 8 with attached stiff mounting element installed to a roof rail of a vehicle;

FIG. 10: a second embodiment of the invention in a view according to FIG. 9; and

FIG. 11: a third embodiment of the invention in a view according to FIG. 9.

### DETAILED DESCRIPTION OF PREFERRED EMBODIMENTS

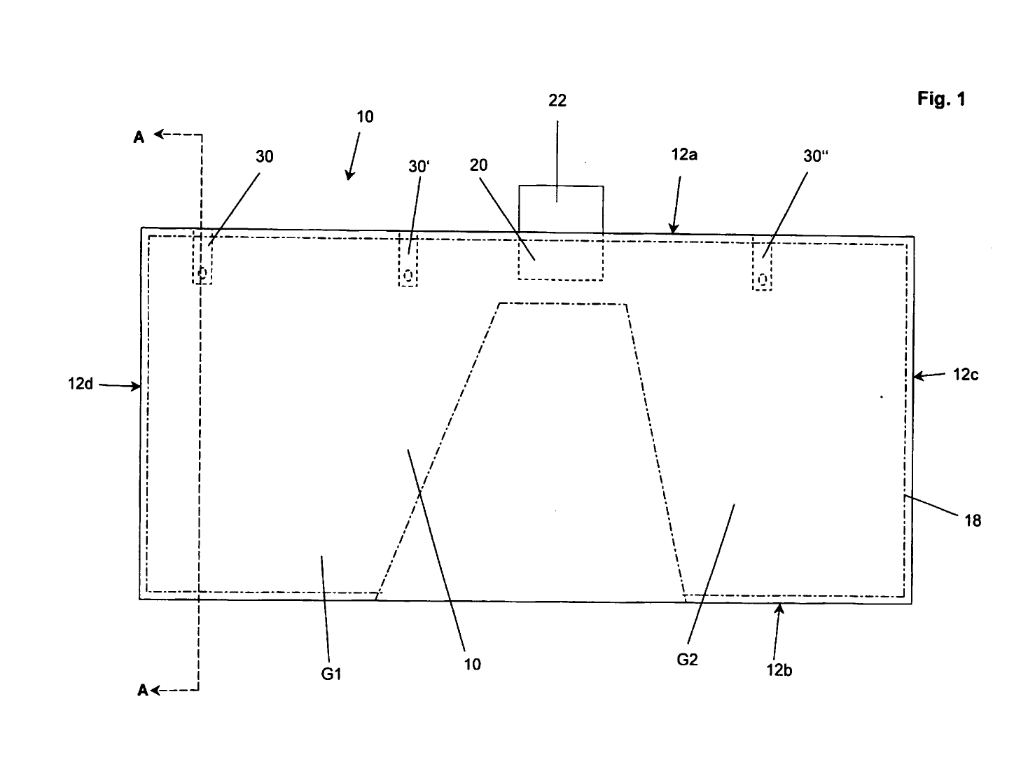

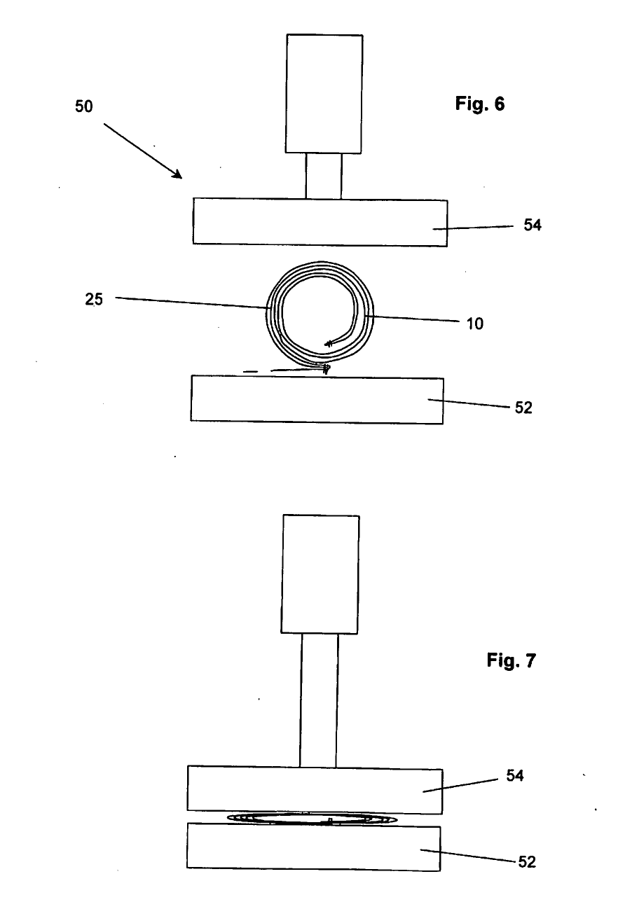

FIGS. 1 to 8 show schematically the last steps in the production of a curtain airbag according to a preferred embodiment of the invention:

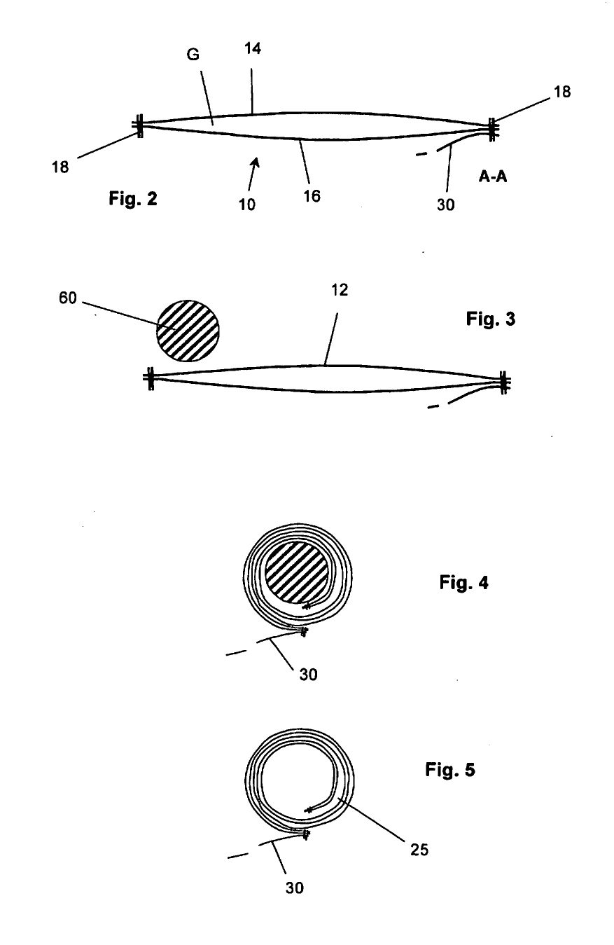

FIG. 1 is a bird eye's view onto an unfolded curtain airbag 10. FIG. 2 is a sects view along plane A-A in FIG. 1. The curtain airbag 10 comprises an-airbag skin 12 with two side walls 14 and 16. The side walls 14 and 16 and thus the airbag skin 12 enclose a gas chamber G which has in the embodiment shown two sub-chambers G1, G2. The airbag skin has four edges, namely an upper edge 12a, a lower edge 12b, a right edge 12c and a left edge 12d. The two side walls are connected to each other by means of an edge seam 18, but it needs to be emphasized that other kinds of connections between the side walls are also possible. For example the airbag skin can be made in a one-piece-woven technique.

Mounting lugs 30, 30′, 30″ are attached to the upper edge; in the embodiment shown by means of the edge seam 18. A gas feed element extends into the gas chamber through a section of the upper edge. This gas feed element 20 whose upper 22 section serves to accommodate a gas generator (not shown) is only drawn very schematically. It can be built like the gas feed element which is disclosed in WO 2006/117121 A1. Other possibilities of feeding the gas into the gas chamber can of course also be used.

Preferably the airbag skin is made of a plastic fabric. A suitable and preferred material for this plastic fabric is polyamide (PA, nylon). It is further preferred that the airbag skin is coated, especially with a coating made of thermoplastic components.

The next step after the assembly of the airbag as such is the rolling of the airbag skin 12. Since it is desired that the rolled package of the airbag skin 10 is hollow, such that the rolled package 25 has the shape of a tube, the rolling can be done by wrapping the airbag skin around a cylinder 60, as is shown FIGS. 3 and 4. After the rolling of the package is completed, the cylinder is removed, such that the rolled package 25 of the airbag skin remains in a state as shown in FIG. 5, namely in form of a tube.

In the next step the curtain airbag 10 is inserted between two plates 52, 54 of a press 50. In this step it can be necessary to keep the rolled package 25 in shape by arranging some elastic bands around its outer surface (not shown). The two plates are heatable and are heated to preferably 80° C. to 110° C. The maximum temperature is limited by the material of the airbag skin and/or the coating of the airbag skin (if any). With the materials described above, the preferred temperature is 110° C.

As shown in FIG. 7, the press is actuated by lowering the upper plate 54 towards the lower plate 52. The force is preferably between 5000 and 10000 N per meter of the rolled airbag skin. A good value for the pressure for the materials and the temperature given above is 7500 N/m. The curtain airbag remains in the press for some time, for example for 5 minutes. In the press, the airbag skin of the rolled package is flattened such that it shows layers that are basically parallel to each other and sharp bending lines along which the airbag skin is bent around 180°. Especially in the areas of the bends, the airbag skin and/or the coating of the airbag skin is thermoplastically deformed. Further it is possible that by the heating and the pressing a certain gluing effect between adjacent layers of the airbag skin in the shaped package occurs.

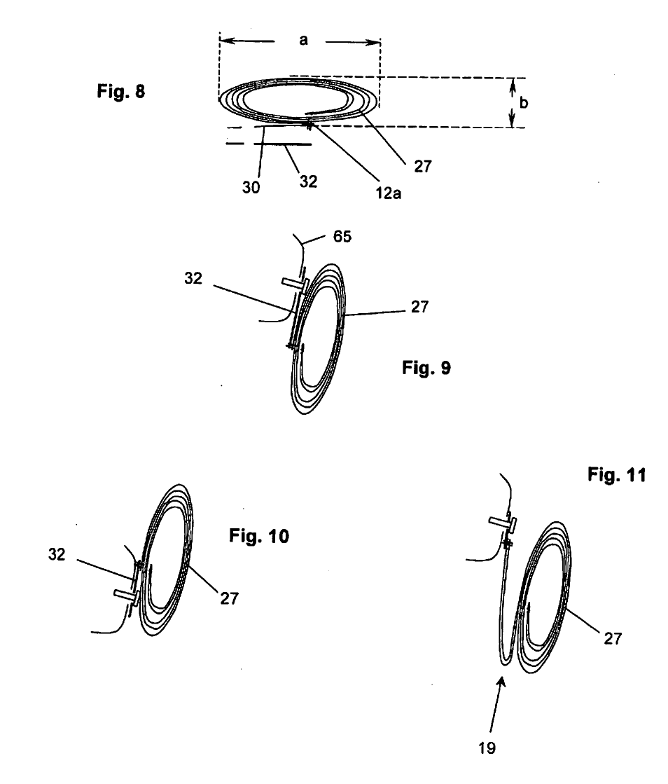

When the press is opened, the rolled package expands to some extend but does not return to its original shape with a circular cross-section due to thermoplastic deformation. This package being obtained form the original rolled package with circular cross-section by the described plastic conversion (or plastic deformation) is referred to as shaped package 27 (FIG. 8). The shape of the shaped package 27 is permanent as long as no sufficient forces are applied, thus in the resting state of the airbag. Of course the shaped package looses its shape when the gas generator is triggered, the pressure inside the gas chambers rises and the airbag deploys.

The cross-section of the shaped package 27 is oval after the plastic deformation of the rolled package 25 with circular cross-section. The areas of the bends show the strongest curvature. It is to be noted here that the amount of the curvature of the airbag skin building the shaped package 27 is not constant (as is a characteristic of an oval) but that the direction of the curvature does not change within the shaped package 27 (as is also a characteristic of an oval). In mathematical terms: The curvature of the airbag skin in the shaped package 27 is monotonous.

Even though mathematically not exact one can say that the shaped package has a longer side with a length a and a shorter side with a length b. Mathematically correct “a” denotes the maximum diameter and “b” denotes the minimum diameter. Preferably a is between 20 mm and 50 mm and b is between 10 mm and 25 mm. Further it is preferred that a is at least 1,5×b.

As one can see from FIG. 8, the upper edge 12a of the airbag skin extends along the longer side (taking the above given definition). As one can also see from FIG. 8, the mounting lugs (shown is mounting lug 30) extend basically parallel to the longer side and end on the upper edge 12a, so that the mounting lug 30 and the shaped package 27 form a “b” in the shown cross-section. A stiff mounting element (shown in FIG. 8 is the stiff mounting element 32) can be attached to each mounting lug 30, 30′, 30″. For example it is possible to glue this stiff mounting element 32—which can especially being made of sheet metal or of plastic—or to lay it inside the mounting lug 30 if this mounting lug 30 is double-walled. With these stiff mounting elements 32 it is achieved that the curtain airbag can be mounted in such a way at the roof rail 65 of a vehicle, that the longer side of the shaped package extends basically in an up-down-direction which is usually preferred (FIG. 9).

FIG. 10 shows a second embodiment in a sectional view according to claim 8. The difference to the first embodiment is that the orientation of the mounting lugs 30 and the stiff mounting elements 32 is opposite: The mounting lug 30 and the shaped package form a “p”.

FIG. 11 shows a third embodiment in a sectional view according to claim 8. Here, the airbag skin has two sections: A first section being rolled to a rolled package and deformed to a shaped package with an oval cross-section as described above, and a second section extending between the first section and the upper edge showing one fold 19. This fold can be applied before or after the plastic deformation of the package.

In the first two embodiments usually no wrapper or similar is needed in order to keep the shaped package in its shape. The third embodiment will usually need one or more wrappers in order to keep its shape.

In the embodiments described the shaped packages have a basically oval cross section and are obtained by plastic deformation of rolled packages with usually circular cross-sections. This shape is usually preferred since it can be made with a simple press with two plates. But it is also possible to generate a shaped package with a more complex cross-section, for example a triangular cross-section. The advantage of such a shape can be that the curtain airbag does even better fit into the space available between the roof rail and the ceiling. A drawback is that a more complicated press, namely one with at least three plates is necessary.

Although the invention has been described at the example of curtain airbags, which is likely to be the most important application, it needs to be emphasised that an airbag according to the invention can also be another kind of airbag, especially a side airbag or a knee airbag.

### LIST OF REFERENCE NUMBERS

10 curtain airbag
12 airbag skin
12a upper edge
12b lower edge
12c right edge
12d left edge
14 first side wall
16 second side wall
18 edge seam
19 fold
20 gas feed element
22 upper section of the gas feed element
25 rolled package
27 shaped package
30,30′,30″ mounting lug
32 stiff mounting element
50 press
52 lower plate
54 upper plate
60 cylinder
65 roof rail
G gas chamber
G1,G2 sub-chamber

1-16. (canceled)

17. An airbag for a motor vehicle comprising:
an airbag skin having two side walls which enclose a gas chamber, the airbag skin being at least partially rolled to a shaped package in the resting state of the airbag, with the shaped package having a non-circular cross-section, the non-circular cross-section permanent as long as a pressure inside the gas chamber does not exceed the pressure of the environment and is obtainable by plastic conversion of a rolled package with a circular cross-section.

18. The airbag according to claim 17, wherein the direction of curvature of the side walls in the shaped package is monotonous.

19. The airbag according to claim 17, wherein the shaped package has a longer side and a shorter side.

20. The airbag according to claim 19, wherein the longer side is at least 1.5 times as long as the shorter side.

21. The airbag according to claim 19, wherein the shaped package has an oval cross section.

22. The airbag according to claim 17, wherein an edge of the airbag extends along the longer side.

23. The airbag according to claim 17, wherein the mounting elements extend from an edge of the airbag skin.

24. The airbag according to claim 23, wherein the mounting elements comprise at least one stiff mounting element.

25. The airbag according to claim 17, wherein the airbag skin is made of plastic fabric.

26. The airbag according to claim 17, wherein the airbag skin is coated.

27. The airbag according to claim 26, wherein the coating is made of thermoplastic components.

28. The airbag according to claim 17, wherein the airbag is a curtain airbag.

29. A method for manufacturing the airbag of claim 17 comprising:
rolling the airbag skin to a rolled package with a circular cross-section; and
converting the rolled package to the shaped package by pressing onto the package with plates from at least two sides.

30. The method according to claim 29, wherein the pressing is performed with at least 5000 N per meter package.

31. The method according to claim 29, further comprising applying additional heat to the package during pressing.

32. The method according to claim 31, wherein at least one plate is heated to more than 80° C.
